(19) United States
(12) Patent Application Publication
(10) Pub. No.: US 2012/0042235 A1
(43) Pub. Date: Feb. 16, 2012

(54) DESIGN SUPPORT APPARATUS, DESIGN SUPPORT METHOD, AND NON-TRANSITORY COMPUTER-READABLE MEDIUM STORING DESIGN SUPPORT PROGRAM

(75) Inventors: Mari Morimoto, Kawasaki (JP); Tsukasa Tenma, Kawasaki (JP); Ryusuke Akahoshi, Kawasaki (JP); Hirooki Hayashi, Kawasaki (JP)

(73) Assignee: FUJITSU LIMITED, Kawasaki-shi (JP)

(21) Appl. No.: 13/196,108

(22) Filed: Aug. 2, 2011

(30) Foreign Application Priority Data
Aug. 13, 2010 (JP) 2010-181313

(51) Int. Cl. G06F 17/00

(52) U.S. Cl. 715/232

(57) ABSTRACT

A design support apparatus includes a search unit configured to refer to a first database including annotation information pieces added to a first product model and site identification information pieces associated with the annotation information pieces, respectively, and to search, in a second product model, a second site corresponding to a first site identified by the site identification information piece. Each of the site identification information pieces is for identifying the first site to which the associated annotation information piece is added in the first product model. The apparatus further includes a placement unit configured to place the annotation information piece associated with the corresponding site identification information piece at the second site when the search unit determines that the second site exists in the second product model.

### CROSS-REFERENCE TO RELATED APPLICATION

This application is based upon and claims the benefit of priority of the prior Japanese Patent Application No. 2010-181313, filed on Aug. 13, 2010, the entire contents of which are incorporated herein by reference.

### FIELD

The embodiments disclosed herein relate to a design support apparatus, a design support method, and a design support program.

### BACKGROUND

When a designer performs product design using computer aided design (CAD), usually, man-hours of design are reduced or a delivery period is shortened by referring to design data of a product model designed in the past. An example of such a technique is disclosed in Japanese Laid-open Patent Publication No. 2010-086476.

### SUMMARY

According to an aspect of the embodiments, a design support apparatus includes a search unit configured to refer to a first database including annotation information pieces added to a first product model and site identification information pieces associated with the annotation information pieces, respectively, each of the site identification information pieces being for identifying a first site to which the associated annotation information piece is added in the first product model, the search unit being configured to search, in a second product model, a second site corresponding to the first site identified by the site identification information piece, and a placement unit configured to place the annotation information piece associated with the corresponding site identification information piece at the second site when the search unit determines that the second site exists in the second product model.

The object and advantages of the embodiment will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the summary of a design support apparatus according to a first embodiment;

FIG. 2 is a diagram illustrating an example of a configuration of design support apparatus hardware according to a second embodiment;

FIG. 3 is a block diagram illustrating a function of a design support apparatus;

FIG. 4 is a diagram explaining each of pieces of information registered in a registration unit;

FIG. 5 is a diagram illustrating the summary of information stored in a view DB storage unit and an annotation object DB storage unit;

FIG. 6 is a diagram illustrating the content of a model DB storage unit;

FIG. 7 is a diagram illustrating the content of an annotation definition file;

FIG. 8 is a block diagram illustrating a function of a registration unit;

FIG. 9 is a diagram illustrating the content of a view DB;

FIG. 10 is a diagram illustrating the content of an annotation object DB;

FIGS. 11A and 11B are diagrams explaining a relationship between absolute coordinates and relative coordinates;

FIG. 12 is a flowchart illustrating registration processing performed in a design support apparatus;

FIG. 13 is a diagram illustrating the content of a reference plane DB;

FIG. 14 is a diagram illustrating an example of a modification to the view DB;

FIG. 15 is a block diagram illustrating a function of an annotation object setting unit;

FIG. 16 is a diagram explaining an operation performed in an annotation object setting unit; and

FIG. 17 is a flowchart illustrating annotation object setting processing.

### DESCRIPTION OF EMBODIMENTS

In some cases, an explanatory note specifying a particular point of a product model (the problem information of the particular point, a note of caution at the time of the implementation of the particular point, or the like) is added to the design data of the product model, which is intended to be diverted.

However, depending on the addition point of the explanatory note, a problem that it is difficult to search a point of a product model designed this time, to which an explanatory note of a product model designed in the past corresponds, has occurred.

Hereinafter, an embodiment will be described in detail with reference to figures.

First, a design support apparatus according to the embodiment will be described, and after that, the embodiment will be described more specifically. According to the embodiment, by recognizing the problem information of a product model designed in the past or the like, it is possible to facilitate the design of a designer.

### First Embodiment

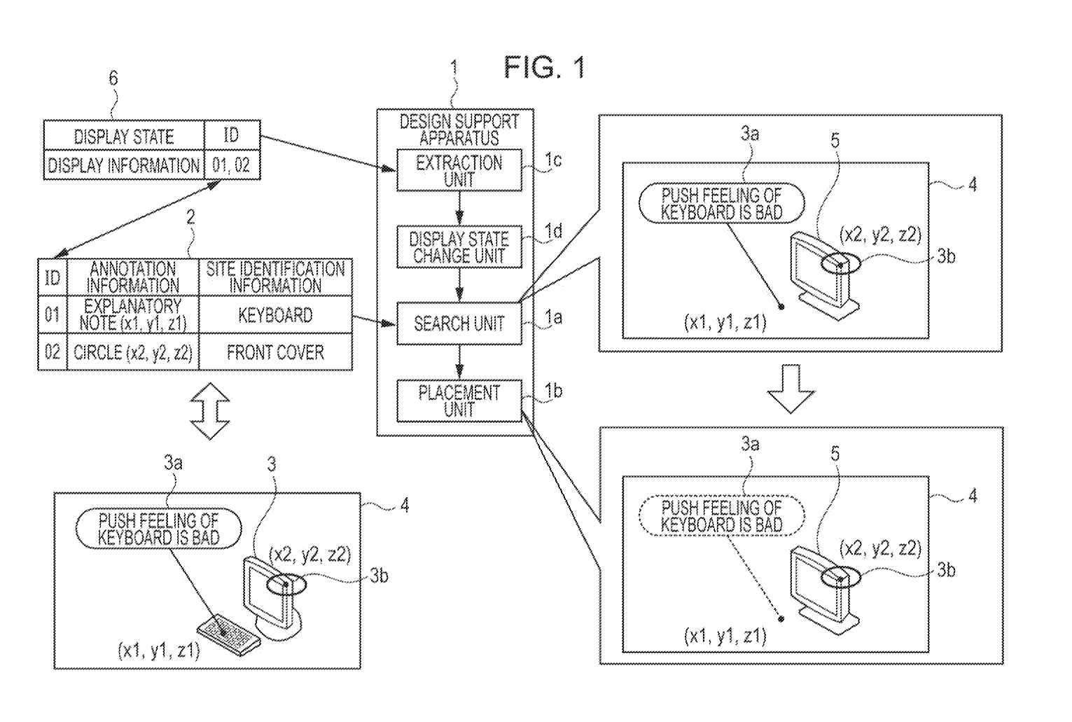

FIG. 1 is a diagram illustrating the summary of a design support apparatus according to a first embodiment.

For example, a design support apparatus (computer) 1 according to the embodiment, illustrated in FIG. 1, is an apparatus that places additional information in a second product model 5 that is a design target, the additional information being added to a first product model 3 the design of which has been finished.

The design support apparatus 1 includes a search unit 1a and a placement unit 1b.

The search unit 1a refers to a first database 2.

In the first database 2, information in which annotation information 3a added to the first product model 3 is associated with site identification information capable of identifying a site where the annotation information 3a corresponds to the first product model 3 and information in which annotation information 3b added to the first product model 3 is associated with site identification information capable of identifying a site where the annotation information 3b corresponds to the first product model 3 are stored. In addition, in the first database 2, IDs for individually identifying pieces of associated information are stored.

FIG. 1 illustrates a diagram illustrating a relationship between the first product model 3 and the pieces of annotation information 3a and 3b when information stored in the first database 2 is displayed on a monitor 4 connected to the design support apparatus 1. The annotation information 3a is information used for displaying an explanatory note on the monitor 4, and the absolute coordinates (x1, y1, z1) of a fore-end indicated by the explanatory note are stored as position information. In addition, the annotation information 3b is information used for displaying an ellipse on the monitor 4, and the absolute coordinates (x2, y2, z2) of the center of the ellipse are stored as position information.

In addition, for example, the absolute coordinates are coordinates indicating a position from an assembly original point specified by a design support program that causes the design support apparatus 1 to execute processing according to the first embodiment, and include coordinate axes common in the first product model 3 and the second product model 5.

In addition, the search unit 1a searches, in the second product model 5, a site corresponding to a site identified by the site identification information. For example, the processing may be executed as follows.

With respect to each of the pieces of annotation information 3a and 3b, the search unit 1a determines whether or not there is a part, identified by the site identification information, at a position identified by the position information of the pieces of annotation information 3a and 3b of the second product model 5, displayed on the screen of the monitor 4 connected to the design support apparatus 1.

Since, in FIG. 1, the second product model 5 has no keyboard, there is no keyboard identified by the identification information, at the absolute coordinates (x1, y1, z1). Accordingly, the search unit 1a determines that there is no part identified by the site identification information, at a position identified by the annotation information 3a.

On the other hand, there is a front cover identified by the site identification information, at the absolute coordinates (x2, y2, z2). In addition, on the basis of the design data of the second product model, it can be determined that a part name existing at the absolute coordinates (x2, y2, z2) of the second product model 5 is the front cover.

In addition, it is desirable that, at the time of determination processing, the search unit 1a performs determination in a state in which the position and posture of the second product model 5 within the monitor 4 are changed to the same position and posture as those of the first product model 3 when the first product model 3 is displayed on the monitor 4. Accordingly, the search unit 1a can more correctly perform determination.

The change of the position and posture of the first product model 3 may be realized on the basis of an extraction unit 1c and a display state change unit 1d. On the basis of an ID, the extraction unit 1c extracts the display state of the first product model 3 from a second database 6 including information in which information (display information) indicating the display state of the first product model 3 is associated with the ID added with respect to each piece of annotation information. In addition, while the content of the display information will be described in detail in a second embodiment, examples of the display information include information relating to the coordinates of the distance from a camera and posture, the camera being virtually installed within the monitor 4 so as to display a direction in which the first product model 3 is viewed and the scaling thereof, information relating to the distance of a model original point from the above-mentioned assembly original point and the rotation direction of the model, and the like.

In addition, the display state change unit 1d causes the display state of the first product model 3, extracted by the extraction unit 1c, and the display state of the second product model 5 to match each other.

In addition, while not illustrated in FIG. 1, the search unit 1a may also determine whether or not a part identified by the site identification information is located adjacent to the position information of the pieces of annotation information 3a and 3b, when it is determined that no part identified by the site identification information exists at the position identified by the pieces of annotation information 3a and 3b.

The placement unit 1b places, at a position identified by the position information, the annotation information 3b determined by the search unit 1a to coincide. In addition, the placement unit 1b may also put the annotation information 3a, determined by the search unit 1a not to coincide, into a display state (for example, dotted line display as illustrated in FIG. 1 or nondisplay) that is different from the display state of the annotation information 3b.

In addition, when the placement unit 1b determines that a part identified by the site identification information is located adjacent to the position identified by the pieces of annotation information 3a and 3b, the placement unit 1b may also cause the annotation information to move to the identified part.

According to the design support apparatus 1, it is possible to reflect the already created annotation information of the first product model 3 in the second product model 5 that is a design target. Therefore, for example, it is possible to clarify a point to be studied by a designer. Accordingly, it is possible to facilitate the design of the designer.

In addition, only the annotation information of a part actually existing in the second product model 5 is displayed, and no annotation information of a part that does not exist is displayed. Accordingly, it is possible to more easily identify a point to be studied in the second product model 5 by the designer.

In addition, it is possible to realize the search unit 1a, the placement unit 1b, and the extraction unit 1c, using a function provided by a central processing unit (CPU) included in the design support apparatus 1.

In addition, while, in the present embodiment, a case has been described in which the first database 2 and the second database 6 are provided outside the design support apparatus 1, one or both of the first database 2 and the second database 6 may be provided within the design support apparatus 1. In this case, a storage unit storing therein the first database 2 and the second database 6 may be realized using a data storage area provided by a random access memory (RAM), a hard disk drive (HDD), or the like, included in the design support apparatus 1.

Hereinafter, the embodiment will be described more specifically.

### Second Embodiment

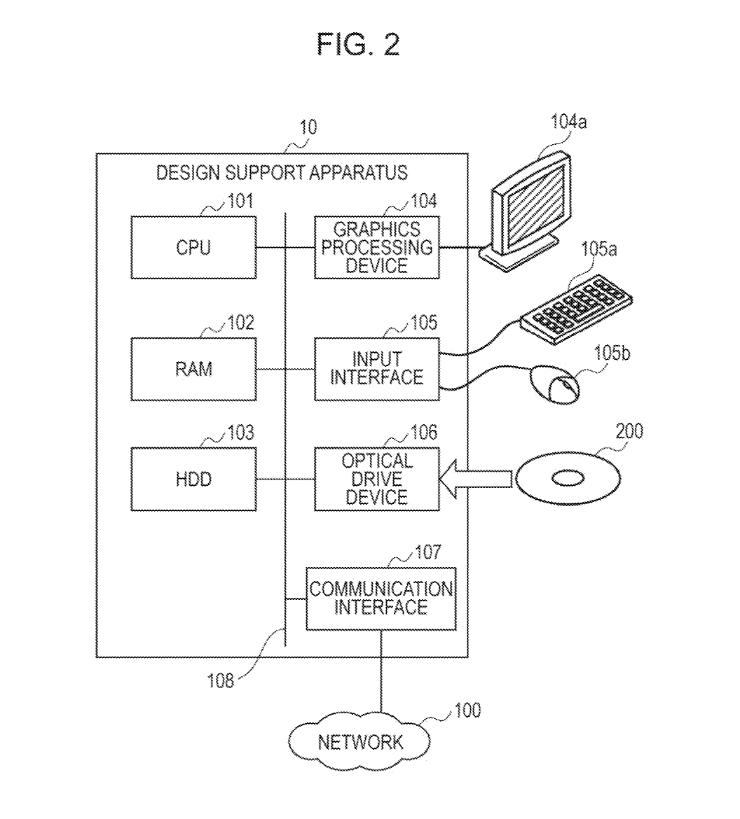

FIG. 2 is a diagram illustrating an example of the configuration of design support apparatus hardware according to a second embodiment.

The whole apparatus of a design support apparatus 10 is controlled by a CPU 101. A RAM 102 and a plurality of peripheral devices are connected to the CPU 101 through a bus 108.

The RAM 102 is used as a main storage device of the design support apparatus 10. At least a portion of a program of an operating system (OS) or an application program to be executed in the CPU 101 is temporarily stored in the RAM 102. In addition, various kinds of data necessary for processing performed in the CPU 101 are stored in the RAM 102.

The peripheral devices connected to the bus 108 include an HDD 103, a graphics processing device 104, an input interface 105, an optical drive device 106, and a communication interface 107.

The HDD 103 magnetically performs writing and readout of data on an embedded disk. The HDD 103 is used as a secondary storage device of the design support apparatus 10. The program of OS, an application program, and various kinds of data are stored in the HDD 103. In addition, as the secondary storage device, a semiconductor storage device such as a flash memory or the like may also be used.

A monitor 104a is connected to the graphics processing device 104. The graphics processing device 104 causes an image to be displayed on the screen of the monitor 104a, in accordance with an instruction from the CPU 101. Examples of the monitor 104a include a display device utilizing a cathode ray tube (CRT), a liquid crystal display device, and the like.

A keyboard 105a and a mouse 105b are connected to the input interface 105. The input interface 105 transmits to the CPU 101a signal sent from the keyboard 105a or the mouse 105b. In addition, the mouse 105b is an example of a pointing device, and another pointing device may also be used. Examples of the other pointing device include a touch panel, a tablet, a touch-pad, a trackball, and the like.

Using laser light or the like, the optical drive device 106 reads out data recorded in an optical disk 200. The optical disk 200 is a portable recording medium in which data is recorded so as to be readable on the basis of the reflection of light. Examples of the optical disk 200 include a digital versatile disc (DVD), a DVD-RAM, a compact disc read only memory (CD-ROM), a CD-recordable (R)/rewritable (RW), and the like.

The communication interface 107 is connected to a network 100. The communication interface 107 transmits and receives data to and from another computer or another communication device through the network 100.

Using such a hardware configuration as described above, a processing function according to the present embodiment can be realized.

The following function is provided in the design support apparatus 10 having such a hardware configuration as described above.

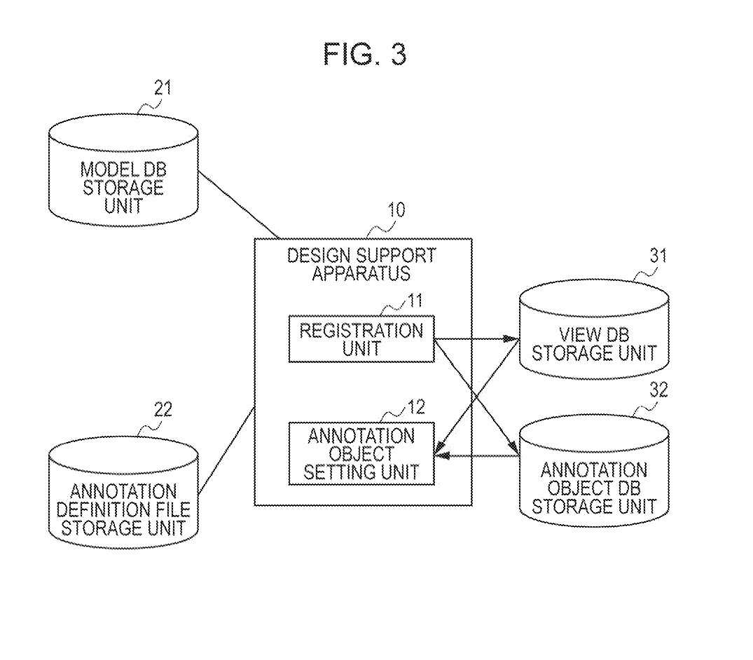

FIG. 3 is a block diagram illustrating the function of the design support apparatus.

The design support apparatus 10 includes a registration unit 11 and an annotation object setting unit 12.

When the designer performs a registration start operation in a state in which a model (registration target model) that is a registration target is displayed on the monitor 104a, the registration unit 11 registers the attribute (view attribute) of a view displayed on the monitor 104a in a view DB (which corresponds to the second database 6 according to the first embodiment). In addition, the registration unit 11 stores the registered view DB in a view DB storage unit 31 provided outside the design support apparatus 10.

In addition, when the designer performs the registration start operation, the registration unit 11 registers an annotation object (annotation information) described later in an annotation object DB (which corresponds to the first database 2 according to the first embodiment) with connecting (associating) the annotation object with the part name and the figure number of a part included in the registration target model, stored in a model DB storage unit 21. In addition, when the connecting is performed, an annotation definition file stored in an annotation definition file storage unit 22 is used.

In addition, the registration unit 11 stores the registered annotation object DB in an annotation object DB storage unit 32 provided outside the design support apparatus 10.

For example, the view DB storage unit 31 and the annotation object DB storage unit 32 may be realized using a hard disk drive, a solid state drive (SSD), or the like.

On the basis of the view DB stored in the view DB storage unit 31 and the annotation object DB stored in the annotation object DB storage unit 32, the annotation object setting unit 12 sets the annotation object in a setting target model in which the designer desires to set the annotation object.

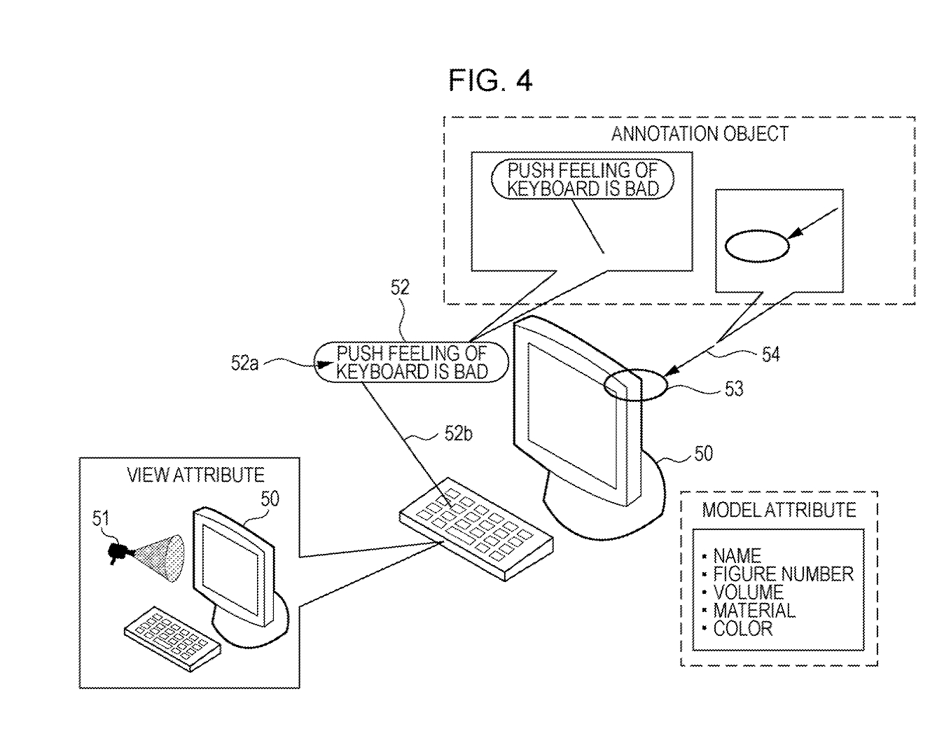

FIG. 4 is a diagram explaining each of pieces of information registered in the registration unit.

As illustrated in FIG. 4, information registered in the registration unit 11 is broadly divided into three types such as a view attribute, an annotation object, and a model attribute (site identification information).

The view attribute indicates the display states of a registration target model such as the state of a view, the position of the registration target model, the posture of the registration target model, the display or nondisplay of a part included in the registered model, the state of a cross-section surface of the registration target model, and the like.

Here, the state of a view includes the coordinates of the distance from a camera 51 and the posture of the registration target model, which indicate a state in which the registration target model (a PC model 50 in FIG. 4) of a CAD displayed on the monitor 104a is displayed.

In addition, view information, annotation information, and a model attribute are preliminarily associated with the registration target model.

Here, the annotation information is information relating to the annotation object. The registration unit 11 refers to the annotation information, thereby allowing the number of annotation objects or the like, set in the registration target model, to be recognized.

In addition, the annotation object means a line or a character such as an explanatory note, a graphic, or the like, which complements 3-D display. For example, in the example illustrated in FIG. 4, annotation text information (explanatory note) 52a for the PC model 50, which indicates “the push feeling of a keyboard is bad”, is described, and a word balloon 52 including a leader 52b, an elliptical shape 53 surrounding the upper right portion of the upper cover of the PC model 50, and an arrow 54 for the elliptical shape 53 individually correspond to annotation objects.

The model attribute means pieces of information added to the registration target model of the CAD and a part included in the registration target model. The model attribute includes the names of a registration target model and a part included in the registration target model, a figure number, a file name, a CAD-ID, a material name, a reference plane, weight, an original point, an outside dimension, volume, relative coordinates, absolute coordinates, a color, a model creation date, a model size, density, the number of component parts, the number of polygons, a shape, a partial shape, a creator, a numerical quantity, a hierarchical level, a unit, and the like.

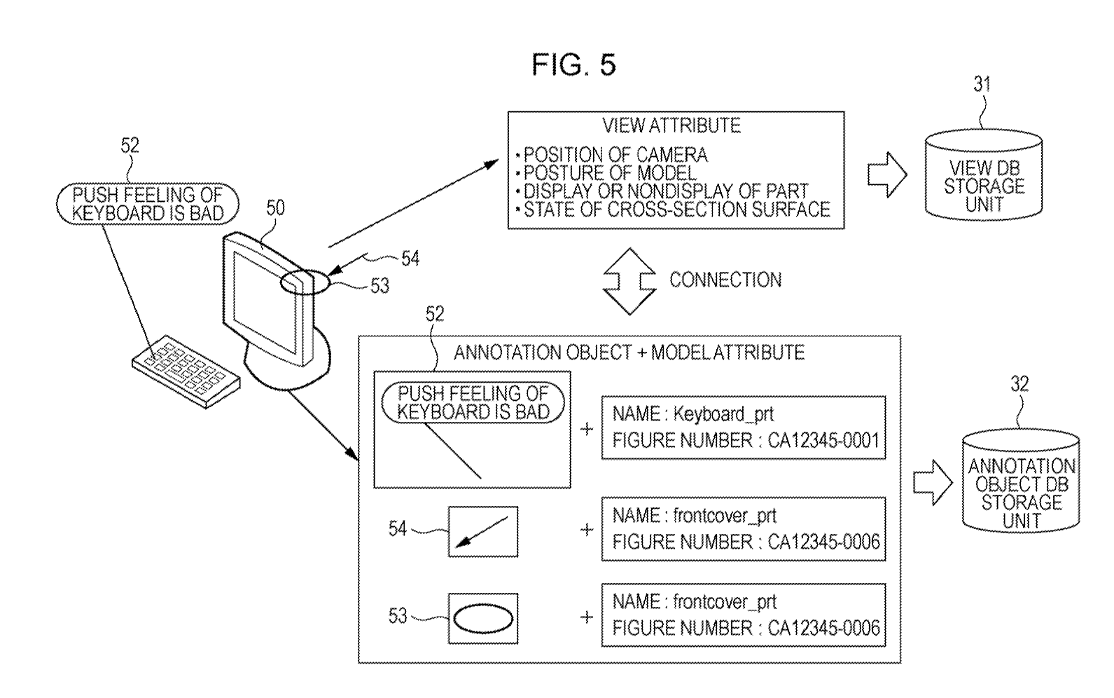

FIG. 5 is a diagram illustrating the summary of information stored in the view DB storage unit and the annotation object DB storage unit.

The view DB storage unit 31 stores therein a view DB including a plurality of pieces of information in which the view information is associated with an annotation object ID used for identifying a combination of an annotation object and a model attribute.

The annotation object DB storage unit 32 stores therein an annotation object DB including a plurality of pieces of information in which a model attribute is connected to an annotation object. For example, in FIG. 5, the annotation object DB storage unit 32 stores therein information that connects a name “Keyboard_prt” used for identifying the keyboard of the PC model 50 and a corresponding figure number “CA12345-0001”, stored in the model DB storage unit 21, to the word balloon 52, information that connects a name “frontcover_prt” used for identifying the front cover of the display of the PC model 50 and a corresponding figure number “CA12345-0006” to the arrow 54, and information that connects the name “frontcover_prt” and the corresponding figure number “CA12345-0006” to the elliptical shape 53.

Next, information stored in the model DB storage unit 21 will be described in detail.

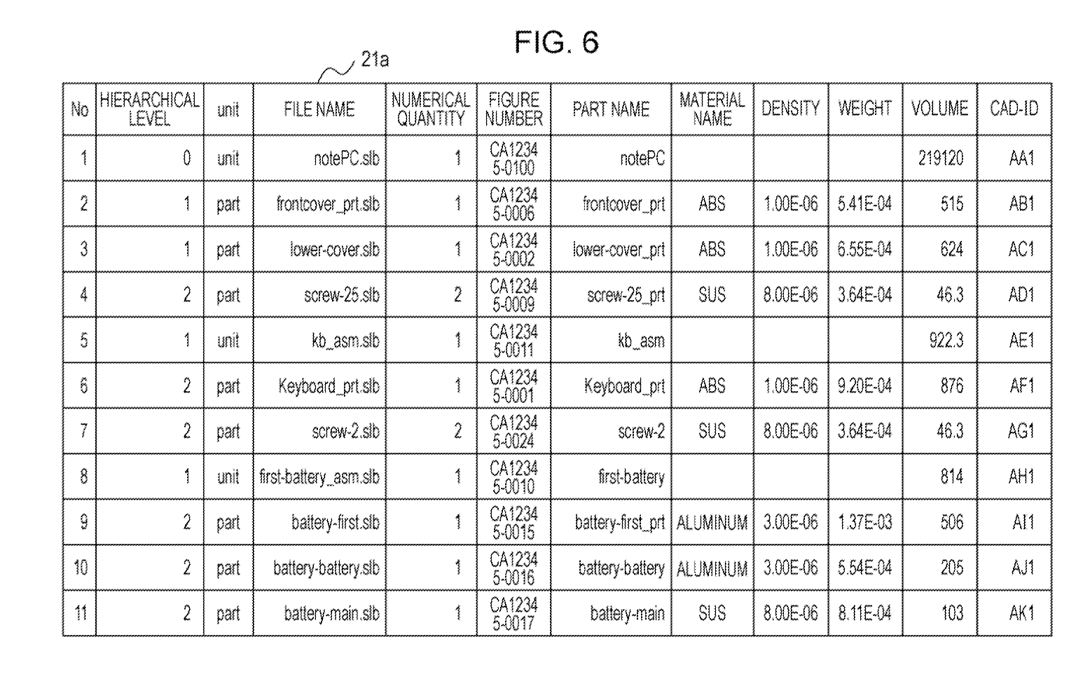

FIG. 6 is a diagram illustrating the content of the model DB storage unit.

In the model DB storage unit 21, the information is arranged in table form and stored.

In the model DB 21a, the columns of a number (No.), a hierarchical level, a unit, a file name, a numerical quantity, a figure number, a part name, a material name, density, weight, volume, a CAD-ID are provided. Pieces of information arranged in a horizontal direction are associated with one another, and form one piece of model information.

In the column of No., a number used for managing the model information within the model DB 21a is set.

In the column of the hierarchical level, a value indicating the hierarchy of a part included in a model is stored. For example, a value “0” indicates a topmost hierarchy, and a value indicates a lower hierarchy with an increase in the value.

In the column of the unit, one of a “Unit” itself including one completed part or a “part” that is combined with another part thereby becoming a completed part is stored.

In the column of the file name, a file name used for simulation of a part is stored. The file name includes a part name in the column of the part name described later+extension (.slb).

In the column of the numerical quantity, the number of completed products or parts used in the model is stored.

In the column of the figure number, a figure number associated with a part is stored.

In the column of the part name, a name for identifying a part is stored.

In the column of the material name, the constituent material of a part is stored with respect to the part where the column of the unit is “part”.

In the column of the density, the density of the constituent material of a part is stored.

In the column of the weight, the weight of the constituent material of a part is stored.

In the column of the volume, the volume of a part is stored.

In the column of the CAD-ID, an identification number used when a part is managed on the CAD system is stored.

Next, an annotation definition file will be described.

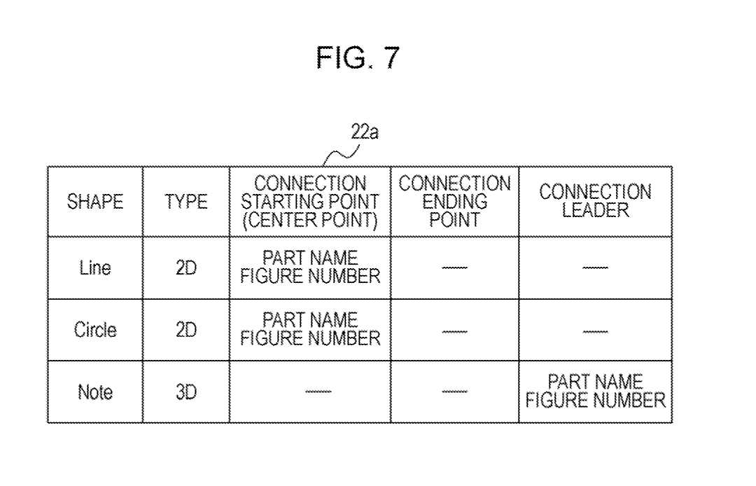

FIG. 7 is a diagram illustrating the content of the annotation definition file.

The content of an annotation definition file 22a is arranged in table form.

In the annotation definition file 22a, the columns of a shape, a type, a connection starting point (center point), a connection ending point, and a connection leader are provided. Pieces of information arranged in a horizontal direction are associated with one another.

In the column of the shape, information for identifying the shape of an annotation object is set. “Line” indicates that the annotation object is a straight line. “Circle” indicates that the annotation object is a circular form. “Note” indicates that the annotation object is an explanatory note.

In the column of the type, information for identifying whether or not the annotation object is a two-dimensional notation or a three-dimensional notation is set.

In the column of the connection starting point (center point), a model attribute is set that connects the starting point of a line segment to the annotation object when the shape is “Line” or connects the center point of a circle to the annotation object when the shape is “Circle”. In addition, a portion in which a hyphen “-” is set indicates that there is no corresponding model attribute.

In the column of the connection ending point, a model attribute connecting the ending point of a line segment to the annotation object is set when the shape is “Line”. In addition, in the present embodiment, the hyphen “-” is set.

In the column of the connection leader, the model attribute of a connection target that is a fore-end (leader destination) indicated by a leader is stored when the shape of the annotation object is “Note”.

Incidentally, in addition to the example illustrated in FIG. 7, examples of a combination of the shape of the annotation object and the connection starting point or connection ending point of the annotation object include the following (1) to (29): (1) a combination of a circle ellipse and the center point of the circle ellipse, (2) a combination of a circle ellipse and a point on the circle ellipse, (3) a combination of a line arrow and the starting point of the line, (4) a combination of a line arrow and the ending point of the line, (5) a combination of a line arrow and a point on the line, (6) a combination of a curved line circular arc and the starting point of the curved line circular arc, (7) a combination of a curved line circular arc and the ending point of the curved line circular arc, (8) a combination of a curved line circular arc and the center point of the curved line circular arc, (9) a combination of a curved line circular arc and a point on the curved line circular arc, (10) a combination of a spline and the starting point of the spline, (11) a combination of a spline and the ending point of the spline, (12) a combination of a spline and a point on the spline, (13) a combination of a polygonal shape and the center of the polygonal shape, (14) a combination of a polygonal shape and the corner of the polygonal shape, (15) a combination of a polygonal shape and a point on the line of the polygonal shape, (16) a combination of a 2-D text and a point within a text display range, (17) a combination of a 3-D text and a point within a text display range, (18) a combination of a 3-D text with a leader line and the starting point of the leader line, (19) a combination of a 3-D text with a leader line and the ending point of a leader circle, (20) a combination of a 3-D text with a leader line and a point within a text display range, (21) a combination of an image and a point within an image range, (22) a combination of one of a circle circular arc.curved line.ellipse.spline.line.arrow or a shape obtained by the combination thereof and a point on a model having the largest projected area from the direction thereof among models located within a shape range, (23) a combination of one of a circle circular arc curved line.ellipse.spline.line.arrow or a shape obtained by the combination thereof and a point on a model having the highest percentage from the direction thereof among models located on an element of the shape, (24) a combination of one of a circle circular arc.curved line.ellipse.spline.line.arrow or a shape obtained by the combination thereof and a single point or a plurality of points on a model located within a shape range, (25) a combination of one of a circle circular arc curved line.ellipse.spline.line.arrow or a shape obtained by the combination thereof and a single point or a plurality of points on a model located on an element of the shape, (26) a combination of one of a circle circular arc curved line.ellipse.spline.line.arrow or a shape obtained by the combination thereof and a point on a model located nearest when no model exists within a shape range or on an element of the shape, (27) a combination of one of a circle circular arc curved line.ellipse.spline.line.arrow or a shape obtained by the combination thereof and a single point or a plurality of points on a model having a similar shape when no model exists within a shape range or on an element of the shape, (28) a combination of one of a circle circular arc.curved line.ellipse.spline.line.arrow or a shape obtained by the combination thereof and a single point or a plurality of points within the shape, and (29) a combination of one of a circle circular arc curved line.ellipse.spline.line.arrow or a shape obtained by the combination thereof and a single point or a plurality of points outside the shape.

Hereinafter, processing executed by the registration unit 11 is referred to as “registration processing”, and processing executed by the annotation object setting unit 12 is referred to as “annotation object setting processing”. First, the registration processing will be described, and after that, the annotation object setting processing will be described.

<Registration Processing>

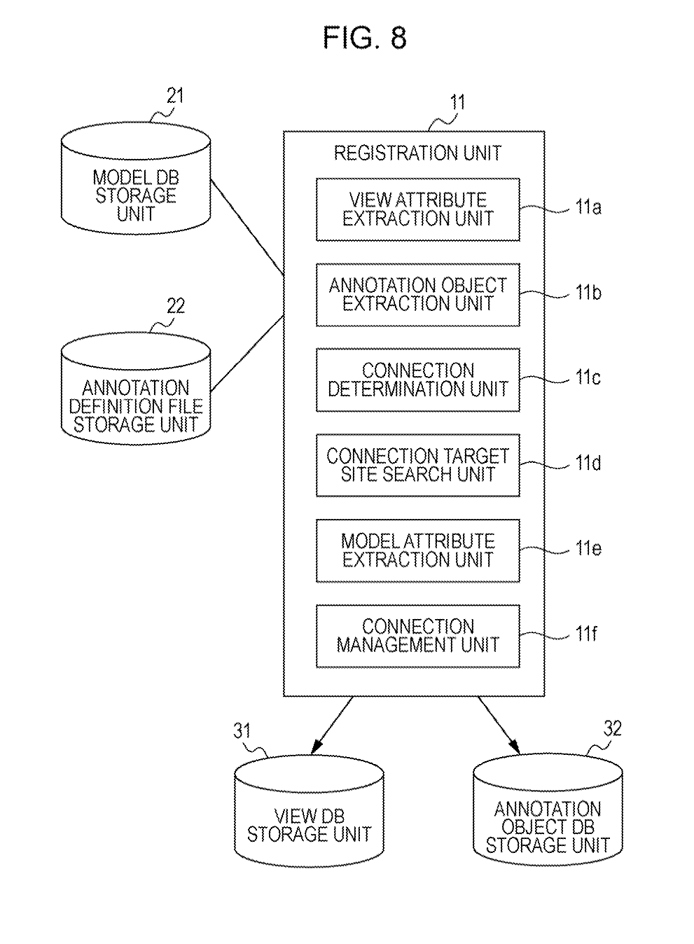

FIG. 8 is a block diagram illustrating the function of the registration unit.

The registration unit 11 includes a view attribute extraction unit 11a, an annotation object extraction unit 11b, a connection determination unit 11c, a connection target site search unit 11d, a model attribute extraction unit 11e, and a connection management unit 11f.

The view attribute extraction unit 11a extracts the view attribute of a registration target model displayed on the monitor 104a from view information the registration target model preliminarily includes.

Specifically, in order to extract the state of a view, the view attribute extraction unit 11a extracts the coordinates of the distance and posture of a camera in a state in which the registration target model is displayed on the monitor 104a. In addition, in order to extract the distance and posture of the registration target model, the view attribute extraction unit 11a extracts the distance from an assembly original point (system original point) to the original point of the registration target model and a registration target model rotation direction.

On the basis of annotation information preliminarily set in the registration target model, the annotation object extraction unit 11b determines whether or not there is an annotation object that has not been extracted yet. In addition, when there is an annotation object that has not been extracted yet, the annotation object extraction unit 11b extracts the annotation object.

The connection determination unit 11c refers to the annotation definition file 22a, and defines the annotation object extracted by the annotation object extraction unit 11b. In addition, the connection determination unit 11c refers to the annotation definition file 22a, and confirms connection conditions such as the part name, the figure number, and the like of the registration target model connected to the annotation object. In addition, in accordance with the confirmation result, the connection determination unit 11c determines whether or not it is necessary to connect the annotation object to the model attribute. For example, when some value is set in the column of the connection starting point, the connection ending point, or the connection leader of the annotation definition file 22a, the connection determination unit 11c determines that it is necessary to connect the annotation object to the model attribute.

In accordance with the determination result of the connection determination unit 11c, the connection target site search unit 11d searches the model attribute of the connection destination of the annotation object.

On the basis of the search result of the connection target site search unit 11d, the model attribute extraction unit 11e extracts the model attribute of the connection target of the annotation object.

The connection management unit 11f connects the annotation object and the extracted model attribute to each other, and furthermore, overwrites the annotation object DB stored in the annotation object DB storage unit 32 with adding the annotation object ID.

In addition, when overwriting of the annotation object DB is completed with respect to all annotation objects extracted by the annotation object extraction unit 11b, the connection management unit 11f creates the view DB.

Specifically, the connection management unit 11f connects a view state, the position of the registration target model, and the posture of the registration target model, extracted by the view attribute extraction unit 11a, to one another and overwrites the view DB stored in the view DB storage unit 31 with adding the annotation object ID added at the time of the overwriting of the annotation object DB.

Next, the content of the view DB stored in the view DB storage unit 31 will be described.

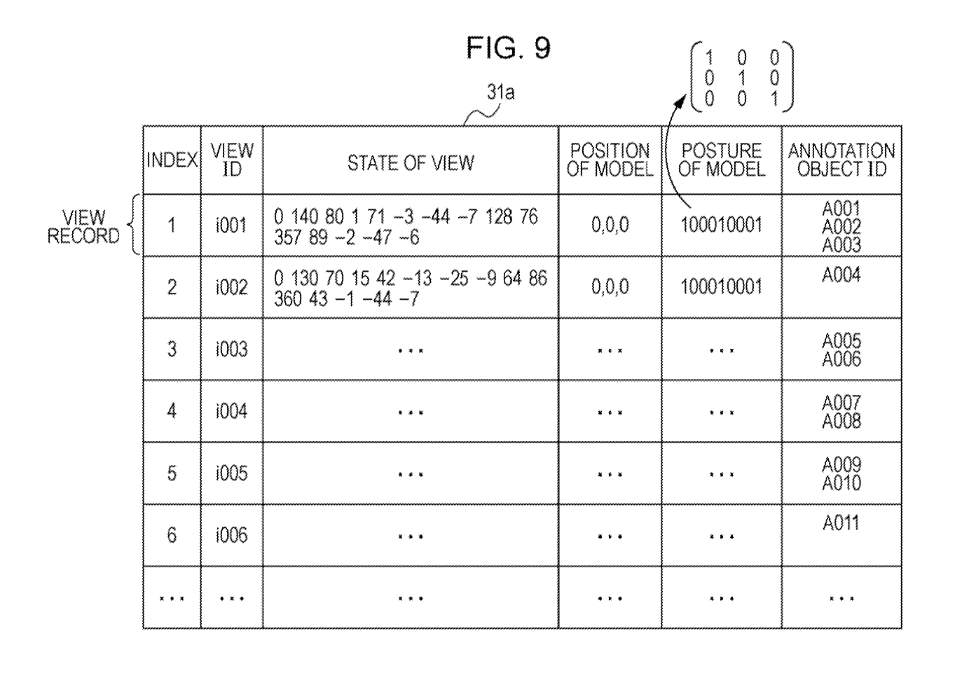

FIG. 9 is a diagram illustrating the content of the view DB.

The content of a view DB 31a is arranged in table form.

In the view DB 31a, the columns of an index, a view ID, a view attribute (the state of a view, the position of a registration target model, and the posture of the registration target model), and an annotation object ID are provided. Pieces of information arranged in a horizontal direction are associated with one another, and form one record (view record).

In the column of the index, a number used for managing the view record within the view DB 31a is set.

In the column of the view ID, a number used for identifying a view record is set.

In the column of the state of a view, the coordinates of the distance and posture of a camera used for displaying the registration target model are stored. For example, values “0 140 80 1 71-3-44-7 128 76 357 89-2-47-6” stored in the column of the state of a view in the view record in the first row sequentially indicate, starting from the leading number, an azimuth angle (=0), a zenith angle (=140), a gaze angle (=(X=80, Y=1, Z=71)), a viewpoint (=(X=−3, Y=−44, Z=−7)), an Up vector (=(X=128, Y=76, Z=357)), an apparent radius (=89), a view angle (=−2), a Z-Near (=−47), and a Z-Far (=−6).

In the column of the position of a model, an X coordinate, a Y coordinate, and a Z coordinate, which indicate the distance from an original point on a system to the original point of the registration target model, are stored.

In the column of the posture of a model, information indicating the posture of the registration target model is stored. For example, values “1 0 0 0 1 0 0 0 1” stored in the column of the state of a view in the view record in the first row indicate the values of a 3-row/3-column rotation matrix.

In the column of the annotation object ID, an annotation object ID is stored that identifies an annotation object connected to a view state.

Next, the content of the annotation object DB stored in the annotation object DB storage unit 32 will be described.

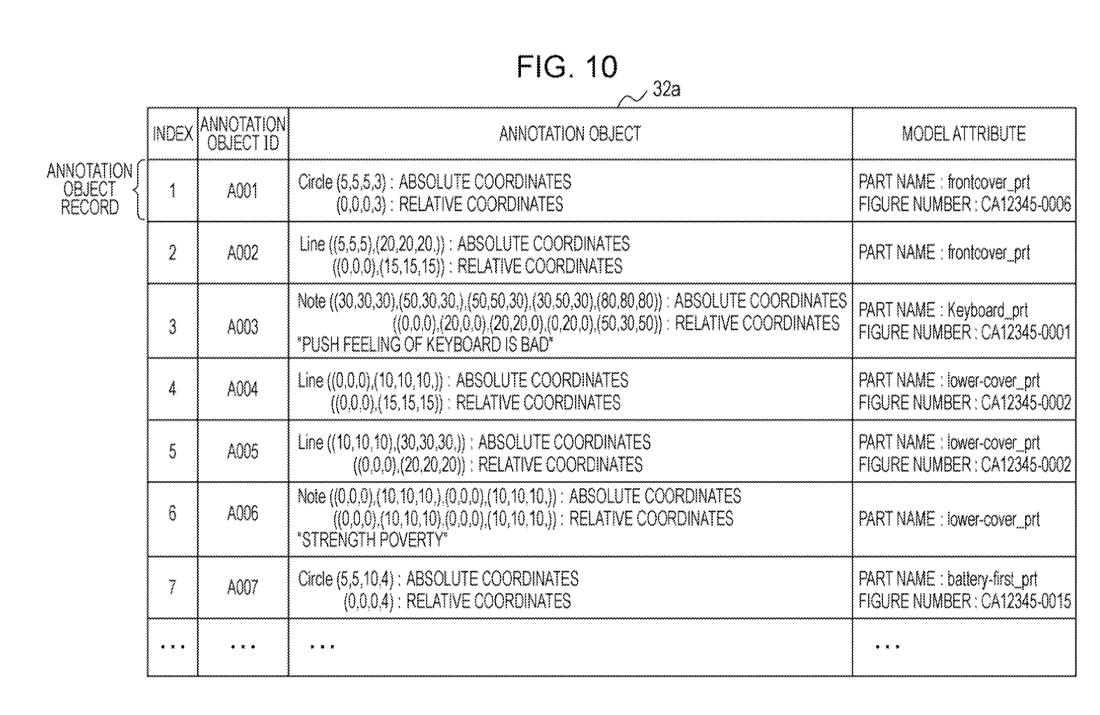

FIG. 10 is a diagram illustrating the content of the annotation object DB.

The content of an annotation object DB 32a is arranged in table form.

In the annotation object DB 32a, the columns of an index, the annotation object ID, the annotation object, and the model attribute are provided. Pieces of information arranged in a horizontal direction are associated with one another, and form one record (annotation object record).

In the column of the index, a number used for managing the annotation object record within the annotation object DB 32a is set.

In the column of the annotation object ID, a number used for identifying an annotation object record is stored.

In the column of the annotation object, pieces of information that indicates the annotation object, namely, the shape of the annotation object and absolute coordinates and relative coordinates indicating the size of the shape, are stored.

Specifically, when the shape of the annotation object is “Circle”, the coordinates of the center point of an ellipse and values indicating the radius of a circle (an orbit semimajor axis and an orbit semiminor axis at the time of an ellipse) are stored. In addition, when the shape of the annotation object is “Line”, the coordinates of the starting point and the ending point of an arrow are stored. In addition, when the shape of the annotation object is “Note”, the coordinates of four points corresponding to the corner portions (it is assumed that the corners thereof are not rounded) of a site (square shape) in which annotation text information for a word balloon is described, coordinates indicating the position of a leader destination, and the annotation text information are stored.

Here, the absolute coordinates are coordinates indicating a position from the assembly original point, and the relative coordinates are coordinates indicating a position from a part original point.

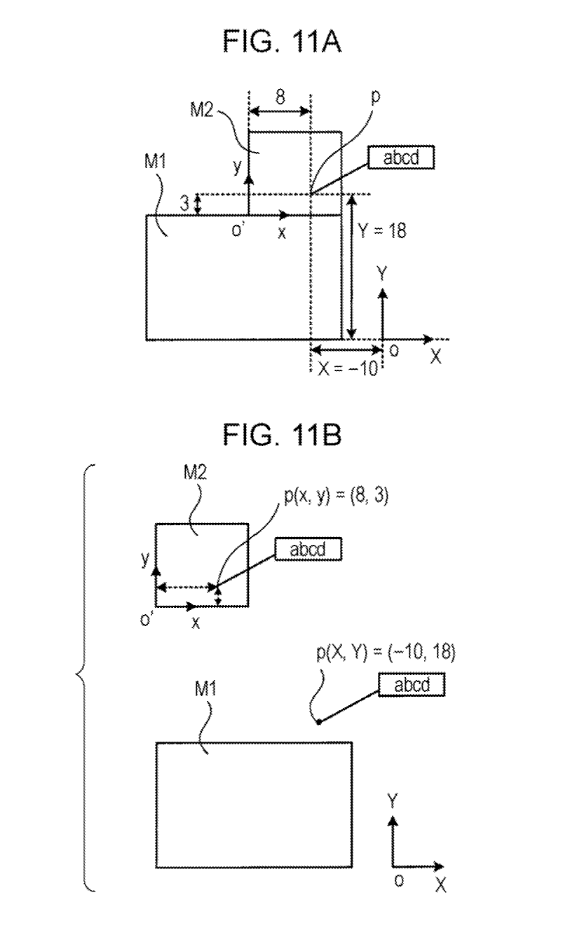

FIGS. 11A and 11B are diagrams explaining a relationship between the absolute coordinates and the relative coordinates.

In FIG. 11A, a model M1 and a model M2, included in the registration target model, and an annotation object “abcd” of the model M2 are illustrated.

The absolute coordinates of the annotation object “abcd” based on an assembly original point o, illustrated in FIG. 11A, are p(X, Y)=(−10, 18). In addition, the relative coordinates with the lower left of the model M2 as an original point o′ are p(x, y)=(8, 3).

When the annotation object “abcd” in FIG. 11A is placed in an assembly in which the model M1 and the model M2 exist away from each other as illustrated in FIG. 11B, a target model does not exist at a position of the absolute coordinates.

Therefore, owing to the relative coordinates p(x, y)=(8, 3) of the annotation object “abcd” from the model M2, it is possible to move the annotation object to a position at which the model exists.

To return to FIG. 10, FIG. 10 will be described again.

In the column of the model attribute, one or both of the part name and the figure number of a model attribute connected to an annotation object are stored.

Next, the registration processing performed in the design support apparatus 10 will be described using a flowchart.

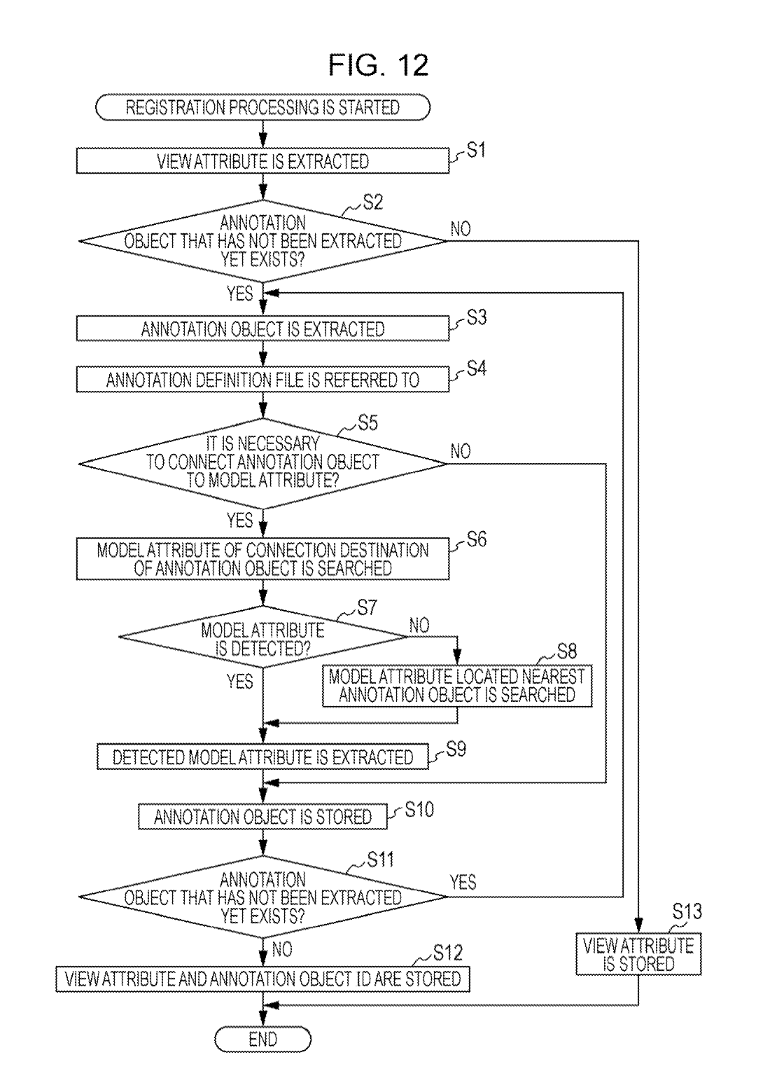

FIG. 12 is a flowchart illustrating the registration processing performed in the design support apparatus.

[Step S1] The view attribute extraction unit 11a extracts, from the view information, the view attribute of the registration target model displayed on the monitor 104a. After that, the processing transits to Step S2.

[Step S2] On the basis of the annotation information preliminarily set in the registration target model, the annotation object extraction unit 11b determines whether or not an annotation object that has not been extracted yet exists with respect to the view attribute extracted in Step S1. In addition, when an annotation object that has not been extracted yet exists (Yes in Step S2), the processing transits to Step S3. When no annotation object that has not been extracted yet exists (No in Step S2), the processing transits to Step S13.

[Step S3] The annotation object extraction unit 11b extracts one annotation object that has not been extracted yet. After that, the processing transits to Step S4.

[Step S4] The connection determination unit 11c refers to the annotation definition file 22a stored in the annotation definition file storage unit 22, and defines the extracted annotation object.

In addition, the connection determination unit 11c refers to the annotation definition file 22a, and confirms a model attribute to be connected to the extracted annotation object.

[Step S5] On the basis of the confirmation result in Step S4, the connection determination unit 11c determines whether or not it is necessary to connect the annotation object to the model attribute. When it is determined that it is necessary to connect the annotation object to the model attribute (Yes in Step S5), the processing transits to Step S6. When it is determined that it is not necessary to connect the annotation object to the model attribute (No in Step S5), the processing transits to Step S11.

[Step S6] The connection target site search unit 11d searches the model attribute confirmed in Step S4. After that, the processing transits to Step S7.

[Step S7] The connection target site search unit 11d determines whether or not the model attribute confirmed in Step S4 has been detected as a result of the search in Step S6. When the model attribute has been detected (Yes in Step S7), the processing transits to Step S9. When the model attribute has not been detected (No in Step S7), the processing transits to Step S8.

[Step S8] The connection target site search unit 11d searches the model attribute confirmed in Step S4, which exists at the nearest position from coordinates at which the annotation object is located. After that, the processing transits to Step S9.

[Step S9] The model attribute extraction unit 11e extracts the model attribute, found as a result of the search operations in Step S7 and Step S8. After that, the processing transits to Step S10.

[Step S10] The connection management unit 11f connects the annotation object and the model attribute extracted in Step S9 to each other, and furthermore, overwrites the annotation object DB 32a stored in the annotation object DB storage unit 32 with adding the annotation object ID. After that, the processing transits to Step S11.

[Step S11] The annotation object extraction unit 11b determines whether or not an annotation object that has not been extracted yet exists. When an annotation object that has not been extracted yet exists (Yes in Step S11), the processing transits to Step S3. When no annotation object that has not been extracted yet exists (No in Step S11), the processing transits to Step S3.

[Step S12] The connection management unit 11f connects a view state, the position of the registration target model, and the posture of the registration target model to one another and overwrites the view DB 31a stored in the view DB storage unit 31 with adding the annotation object ID added to the extracted annotation object. After that, the registration processing is terminated.

[Step S13] The connection management unit 11f stores only the view state in the view DB 31a. After that, the registration processing is terminated.

This is the end of the description of the registration processing.

Next, citing the PC model 50 illustrated in FIG. 4 as an example, a specific example of the registration processing will be described.

The view attribute extraction unit 11a extracts the view attribute of the PC model 50 in a state in which the PC model 50 is displayed on the monitor 104a. Here, it is assumed that the state of a view is defined as “0 140 80 1 71-3-44-7 128 76 357 89-2-47-6”. In addition, it is assumed that the position of the PC model 50 and the posture of a model are defined as “0, 0, 0” and “1 0 0 0 1 0 0 0 1”, respectively.

On the basis of the annotation information preliminarily set in the PC model 50, the annotation object extraction unit 11b determines whether or not an annotation object that has not been extracted yet exists with respect to the view attribute extracted by the view attribute extraction unit 11a. In the present specific example, the word balloon 52, the elliptical shape 53, and the arrow 54 exist.

Hereinafter, a case will be exemplified in which the annotation object extraction unit 11b extracts the elliptical shape 53.

The connection determination unit 11c refers to the column of the shape in the annotation definition file 22a, and defines the extracted elliptical shape 53 as “Circle”. In addition, the connection determination unit 11c refers to the column of the connection starting point (center point), and defines “Circle (5, 5, 5, 3): absolute coordinates (0, 0, 0, 3): relative coordinates” which indicates the absolute coordinates and relative coordinates of the center point of an elliptical shape and the radius of a circle.

In addition, the connection determination unit 11c refers to the annotation definition file 22a, and confirms a model attribute (a part name and a figure number) to be connected to the elliptical shape 53.

Next, on the basis of the confirmation result, the connection determination unit 11c determines whether or not it is necessary to connect the elliptical shape 53 to the model attribute. In the present specific example, since the connection starting point of the shape “Circle” of the elliptical shape 53 corresponds to “part name and figure number”, it is determined that it is necessary to connect the connection starting point of the elliptical shape 53 to the model attribute.

On the basis of the connection starting point (center point) of the elliptical shape 53, the connection target site search unit 11d searches the model attribute of the PC model 50, which exists in the vertical direction of a plane on which the annotation object is drawn. As a result of the search, the model attributes, “part name: frontcover_prt” and “figure number: CA12345-0006”, of a part located nearest the connection starting point are detected.

In addition, in addition to the above-mentioned method, the detected model attributes may also be detected by using a method in which a part whose occupied area is largest in the elliptical shape 53 is detected. In addition, a model attribute that is not displayed in the PC model 50 may also be detected.

Since the connection target site search unit 11d has detected the model attributes, namely, the “part name: frontcover_prt” and the “figure number: CA12345-0006”, the model attribute extraction unit 11e extracts the “part name: frontcover_prt” and the “figure number: CA12345-0006”.

The connection management unit 11f stores the annotation object “Circle (5, 5, 5, 3): absolute coordinates, (0, 0, 0, 3): relative coordinates” in the column of the annotation object in the annotation object DB 32a. In addition, the connection management unit 11f stores the “part name: frontcover_prt” and the “figure number: CA12345-0006” in the column of the model attribute in the annotation object DB 32a. In addition, the connection management unit 11f stores an annotation object ID “A001” in the column of the annotation object ID in the annotation object DB 32a.

The same processing as the above-mentioned example of registration is performed with respect to the arrow 54, and the annotation object, the attribute, and the annotation object ID thereof are registered in the second row in the annotation object DB 32a. In addition, the same processing as the above-mentioned example of registration is performed with respect to the word balloon 52, and the annotation object, the attribute, and the annotation object ID thereof are registered in the third row in the annotation object DB 32a.

This is the end of the description of the specific example of the registration processing.

Next, an example of a modification to the registration processing will be described.

<Example of Modification>

While, in the present embodiment, the connection of the view attribute to the annotation object has been described, information other than the annotation object may also be connected to the view attribute. Hereinafter, a case in which the information of a reference plane is connected to the view attribute will be cited, as an example of a case in which information other than the annotation object is connected to the view attribute, and described.

In order to connect the reference plane to the view attribute, a reference plane DB preliminarily prepared is used. Hereinafter, the content of the reference plane DB will be described.

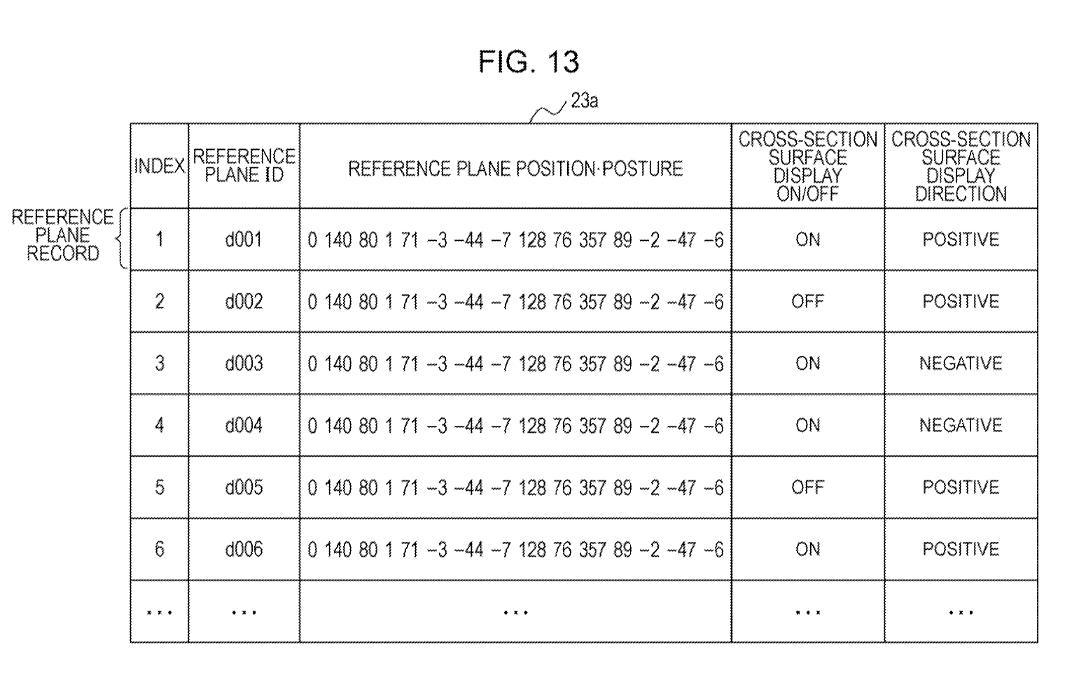

FIG. 13 is a diagram illustrating the content of the reference plane DB.

The content of the reference plane DB is arranged in table form.

In a reference plane DB 23a, the columns of an index, a reference plane ID, a reference plane position posture, a cross-section surface display ON/OFF, and a cross-section surface display direction are provided. Pieces of information arranged in a horizontal direction are associated with one another, and form one record (reference plane record).

In the column of the index, a number used for managing the reference plane record within the reference plane DB 23a is set.

In the column of the reference plane ID, a number used for identifying the reference plane record is set.

In the column of the reference plane position.posture, a number used for identifying the position and posture of the reference plane is set.

In the column of the cross-section surface display ON/OFF, information is set that indicates whether or not the cross-section surface of the reference plane is displayed. When information indicating that the cross-section surface of the reference plane is to be displayed exists in information for managing the PC model 50, “ON” is set. When the information does not exist, “OFF” is set.

In the column of the cross-section surface display direction, information indicating a cross-section surface display direction is set. Specifically, a direction “positive” from the near side of the display plane of the monitor 104a to the far side thereof and a direction “negative” from the far side of the display plane of the monitor 104a to the near side thereof are set.

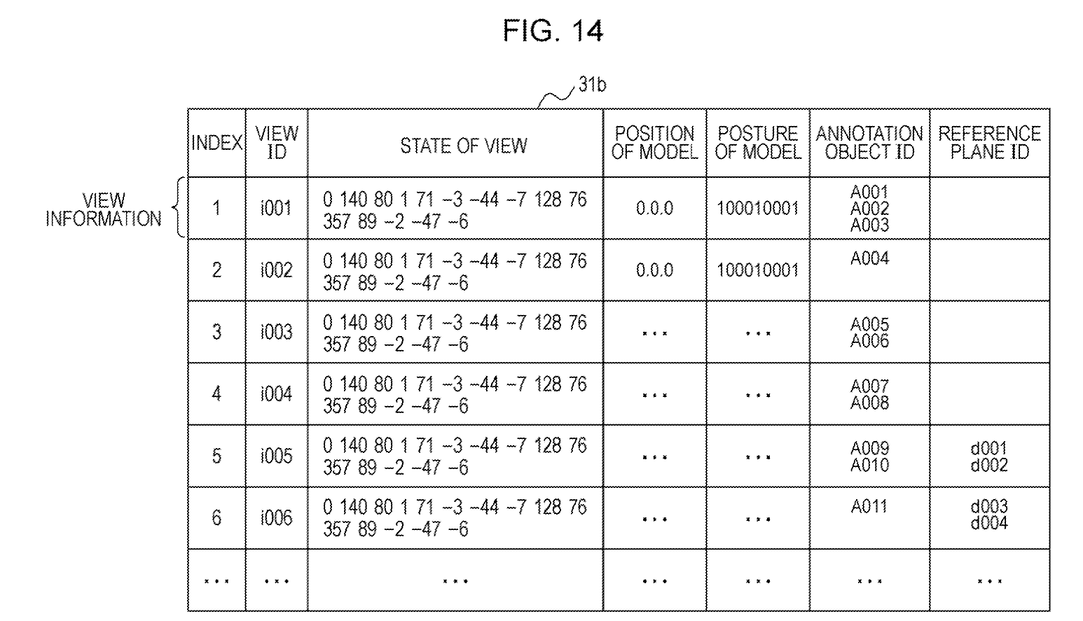

FIG. 14 is a diagram illustrating an example of a modification to the view DB.

A view DB 31b includes the column of a reference plane ID in addition to the columns in the view DB 31a.

In the column of the reference plane ID, a reference plane ID connected to a view state is stored.

In the same way as the method in which the registration unit 11 connects the annotation object ID to the view attribute, the design support apparatus 10 connects the reference plane ID to the view attribute, and stores the reference plane ID in the view DB 31b.

This is the end of the description of the registration processing.

Next, the annotation object setting processing for setting the annotation object in the setting target model will be described.

<Annotation Object Setting Processing>

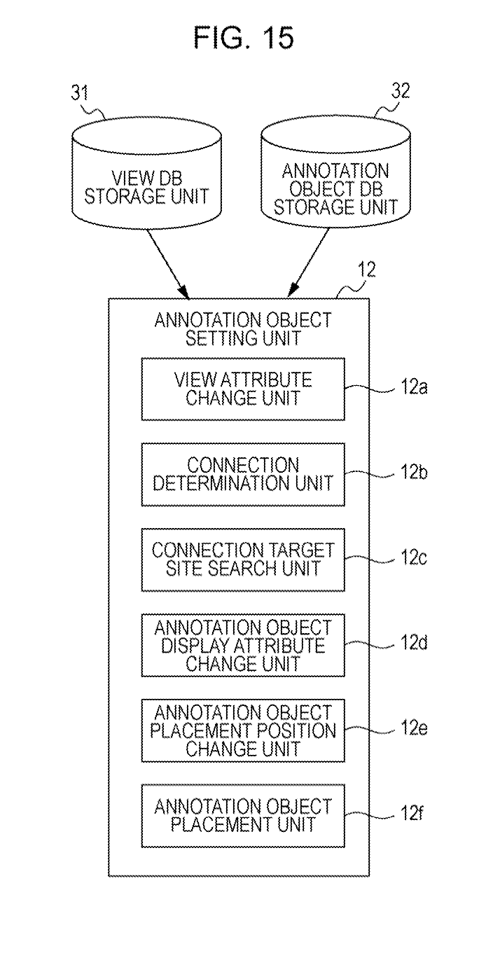

FIG. 15 is a block diagram illustrating the function of the annotation object setting unit.

The annotation object setting unit 12 includes a view attribute change unit 12a, a connection determination unit 12b, a connection target site search unit 12c, an annotation object display attribute change unit 12d, an annotation object placement position change unit 12e, and an annotation object placement unit 12f.

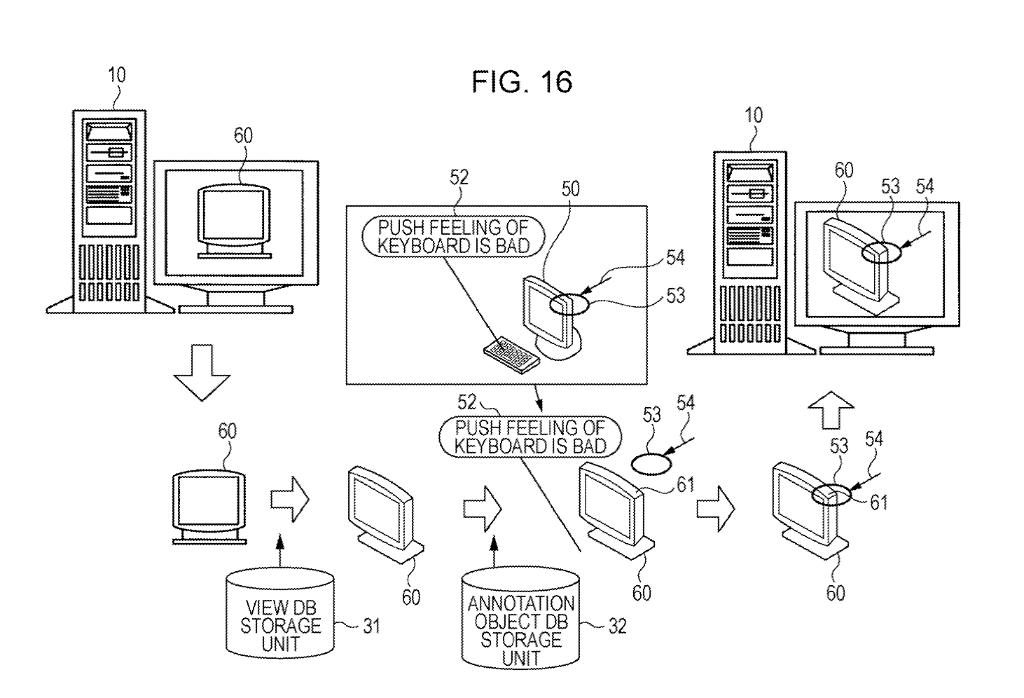

Hereinafter, the individual functions of the annotation object setting unit 12 will be described with reference to FIG. 16.

FIG. 16 is a diagram explaining an operation performed in the annotation object setting unit.

In order to set the annotation object registered by the registration unit 11 on a setting target model 60, a designer operates a keyboard 105a or a mouse 105b, thereby instructing the design support apparatus 10 to start the setting of the annotation object.

The view attribute change unit 12a refers to the view DB 31b, and extracts a view attribute and an annotation object ID to be set on the setting target model 60. In addition, the view attribute change unit 12a changes the view of the setting target model 60 in accordance with the extracted view attribute. In FIG. 16, the position and posture of the view of the setting target model 60 are changed to the same as those of the view of the PC model 50.

On the basis of the annotation object ID, the connection determination unit 12b extracts the annotation object and the model attribute, connected to the view attribute. In FIG. 16, a case is illustrated in which the word balloon 52, the elliptical shape 53, and the arrow 54 are extracted.

The connection target site search unit 12c searches a connection target site in the setting target model 60, which matches the condition of a model attribute.

For example, as illustrated in FIG. 16, when the annotation object is the word balloon 52, a connection target site in the setting target model 60 is searched that matches the absolute coordinates of the leader destination of the word balloon 52. In addition, when a coincident connection target site is found, the search processing is terminated. On the other hand, when a coincident connection target site is not found, the connection target site search unit 12c searches a condition matching the model attribute within a range in which the setting target model is displayed, on the basis of the absolute coordinates of the leader destination of the word balloon 52.

Specifically, a spherical shape is created from the absolute coordinates of the leader destination, and the radius of the sphere is increased until a connection target site can be found. In addition, the part name of a connection target site in contact with the spherical shape is extracted as the part name of a placement target.

In addition, a created shape may be a cube or a circular cone in place of the spherical shape. In addition, when there are a plurality of contiguous part names, a part name to be extracted may be determined on the basis of the largeness of contiguous volume or the like. In addition, the center of the sphere may be moved using another index.

In FIG. 16, since the setting target model 60 has no keyboard, it is assumed that the connection target site of the setting target model 60 matching the word balloon 52 is not found. In addition, it is assumed that the part name of a site 61 of the setting target model 60 is “frontcover_prt” and matches the conditions of the model attributes of the elliptical shape 53 and the arrow 54.

On the basis of the search result of the connection target site search unit 12c, the annotation object display attribute change unit 12d changes the display attribute of the annotation object. In FIG. 16, since no connection target site of the setting target model 60 matching the word balloon 52 is found, the word balloon 52 is changed to nondisplay.

On the basis of the search result of the connection target site search unit 12c, the annotation object placement position change unit 12e changes the placement position of the annotation object. In FIG. 16, the placement positions of the elliptical shape 53 and the arrow 54 are changed to the site 61 of the setting target model 60.

The annotation object placement unit 12f places the annotation object at the changed placement position. In FIG. 16, the elliptical shape 53 and the arrow 54 are placed at the site 61 of the setting target model 60.

Next, the annotation object setting processing will be described using a flowchart.

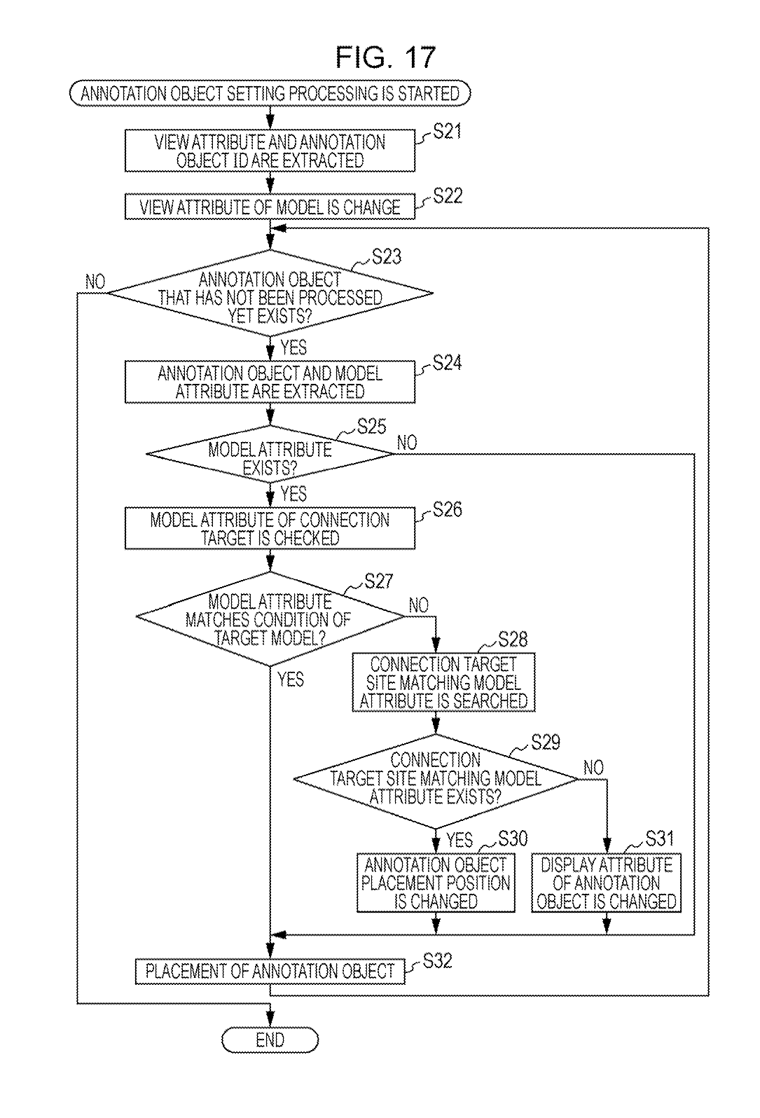

FIG. 17 is a flowchart illustrating the annotation object setting processing.

[Step S21] The view attribute change unit 12a refers to the view DB 31a, and extracts the view attribute and the annotation object ID (in the presence thereof) to be set in the setting target model. After that, the processing transits to Step S22.

[Step S22] The view attribute change unit 12a changes the view of the setting target model in accordance with a display state indicated by the view attribute extracted in Step S21. After that, the processing transits to Step S23.

[Step S23] The connection determination unit 12b determines whether or not an annotation object that has not been processed yet (has not been subjected to processing operations executed in Step S24 to Step S32) exists among annotation objects corresponding to the annotation object IDs extracted in Step S21. When an annotation object that has not been processed yet exists (Yes in Step S23), the processing transits to Step S24. When no annotation object that has not been processed yet exists or no annotation object ID exists in the view record (NO in Step S23), the annotation object setting processing is terminated.

[Step S24] The connection determination unit 12b selects one of annotation object IDs of annotation objects that have not been processed yet. In addition, the connection determination unit 12b refers to the annotation object DB 32a, and extracts the annotation object and the model attribute (in the presence thereof) of an annotation object record including an annotation object ID that matches the selected annotation object ID. After that, the processing transits to Step S25.

[Step S25] The connection determination unit 12b determines whether or not a model attribute exists in the information extracted in Step S24. When the model attribute exists (Yes in Step S25), the processing transits to Step S26. When no model attribute exists (No in Step S25), the processing transits to Step S32.

[Step S26] The connection determination unit 12b checks the condition of the model attribute extracted in Step S24. Specifically, the connection determination unit 12b checks whether or not a part name existing at the position of the annotation object is a part name or a figure number, registered in the model attribute. After that, the processing transits to Step S27.

[Step S27] On the basis of the search result in Step S26, the connection determination unit 12b determines whether or not the condition of the model attribute of the annotation object to be set matches the condition of the setting target model. When at least one of the “part name” and the “figure number” coincides (Yes in Step S27), the processing transits to Step S32. When none of the “part name” and the “figure number” coincides (No in Step S27), the processing transits to Step S28.

[Step S28] The connection target site search unit 12c searches a connection target site of the setting target model matching the condition of a model attribute. Specifically, the connection target site search unit 12c searches a condition matching the model attribute within a range in which the setting target model is displayed, on the basis of the position of the annotation object to be set. After that, the processing transits to Step S29.

[Step S29] On the basis of the search result in Step S28, the connection target site search unit 12c determines whether or not a connection target site matching the condition within the setting target model has been found. When the connection target site has been found (Yes in Step S29), the processing transits to Step S30. When no connection target site has been found (No in Step S29), the processing transits to Step S31.

[Step S30] On the basis of the search result in Step S28, the annotation object placement position change unit 12e changes the placement position of the annotation object. After that, the processing transits to Step S32.

[Step S31] The annotation object display attribute change unit 12d changes the display attribute of the annotation object. For example, the annotation object display attribute change unit 12d puts the annotation object to be set, into a nondisplay state or a semi-transparent state. After that, the processing transits to Step S32.

[Step S32] The annotation object placement unit 12f places the annotation object at a placement position. When the placement position is changed in Step S30, the annotation object is placed at the changed placement position. After that, the processing transits to Step S23.

This is the end of the description of the annotation object setting processing.

Next, a specific example of the annotation object setting processing will be described using the view DB 31a illustrated in FIG. 9 and the annotation object DB 32a illustrated in FIG. 10.

The view attribute change unit 12a refers to the view DB 31a, and extracts the view state “0 140 80 1 71-3-44-7 128 76 357 89-2-47-6”, the model position “0, 0, 0”, and the model posture “1 0 0 0 1 0 0 0 1” of the annotation object (view ID: “i001”) that is a setting target.

When referring to the column of the annotation object ID in the view DB 31a, the view attribute change unit 12a recognizes that the annotation (view ID: “i001”) of the setting target corresponds to annotation object IDs “A001”, “A002”, and “A003”.

The view attribute change unit 12a changes the view of the setting target model in accordance with the extracted display state. Specifically, the view attribute change unit 12a changes the view state “0 140 80 1 71-3-44-5 432 76 543 21-2-47-6” of the setting target model before the change to “0 140 80 1 71-3-44-7 128 76 357 89-2-47-6”. In addition, the view attribute change unit 12a changes the position “1, 0, 1” of the setting target model before the change to “0, 0, 0”. In addition, the view attribute change unit 12a changes the posture “1 1 0 0 1 0 0 0 1” of the setting target model before the change to “1 0 0 0 1 0 0 0 1”.

After determining whether or not the annotation object ID exists in the information extracted by the view attribute change unit 12a, first the connection determination unit 12b starts the placement processing for the annotation object with respect to the annotation object record of the annotation object ID “A001” because there are the annotation object IDs “A001”, “A002”, and “A003”.

First, the connection determination unit 12b refers to the annotation object and the column of the model attribute of the annotation object ID “A001” in the annotation object DB 32a, and extracts the annotation object “Circle (5, 5, 5, 3): absolute coordinates, (0,0,0,3): relative coordinates” and the model attributes “part name: frontcover_prt” and “figure number: CA12345-0006”.

When the connection determination unit 12b determines whether or not the model attribute exists in the extracted information, the model attributes “part name: frontcover_prt” and “figure number: CA12345-0006” exist. Accordingly, the connection determination unit 12b checks the condition of the extracted model attribute. Specifically, the connection determination unit 12b checks whether the part name of the PC existing at the absolute coordinates (5, 5, 5) and relative coordinates (0, 0, 0) of the extracted annotation object corresponds to the “part name: frontcover_prt” or the “figure number: CA12345-0006”.

In the present specific example, it is assumed that the part name of the PC existing at the absolute coordinates (5, 5, 5) and relative coordinates (0, 0, 0) of the extracted annotation object corresponds to the “part name: frontcover_prt” and the “figure number: CA12345-0006”.

The annotation object placement unit 12f places the annotation object extracted by the connection determination unit 12b at the absolute position (5, 5, 5).

Next, the same processing as that for the annotation object ID “A001” is performed for an annotation object record of the annotation object ID″ A002″, the annotation object is placed at the absolute position (5, 5, 5).

After that, since the annotation object of the annotation object ID “A003” remains, the connection determination unit 12b extracts, from the annotation object DB 32a extracted by the view attribute change unit 12a, an annotation object “Note ((30, 30, 30), (50, 30, 30), (50, 50, 30), (30, 50, 30), (80, 80, 80)): absolute coordinates, ((0, 0, 0), (20, 0, 0), (20, 20, 0), (0, 20, 0), (50, 30, 50)): relative coordinates, annotation text information “the push feeling of a keyboard is bad”” and model attributes “part name: Keybord_prt and figure number: CA12345-0001”.

In addition, when the connection determination unit 12b determines whether or not the model attribute exists in the extracted information, the model attribute exists. Therefore, the connection determination unit 12b checks whether the part name of the setting target model existing at the absolute coordinates (80, 80, 80) of the leader destination of the annotation object “Note” corresponds to the “part name: Keyboard_prt” or the “figure number: CA12345-0001”, registered in the model attribute.

In the present specific example, it is assumed that the part name of the setting target model existing at the absolute coordinates (80, 80, 80) does not correspond to the “part name: Keyboard_prt” nor the “figure number: CA12345-0001”, registered in the model attribute.

The connection target site search unit 12c searches a condition matching the model attribute within a range in which the setting target model is displayed, on the basis of the absolute coordinates (80, 80, 80) of the leader destination of the annotation object to be set.

Specifically, as described above, the radius of the sphere whose center is located at the absolute coordinates (80, 80, 80) of the leader destination is increased until a setting target model can be detected. In addition, a part name in contact with the spherical shape is extracted as the part name of a placement target.

As a result of the search, a connection target matching the condition is not found within the setting target model. Therefore, when a connection target matching the condition is not found, the annotation object display attribute change unit 12d changes the display attribute of the annotation object to nondisplay.

When all processing operations for the annotation object IDs “A001”, “A002”, and “A003” have been performed, the annotation object setting unit 12 finishes the annotation object setting processing.

As described above, according to the annotation object setting unit 12, it is possible to reflect an annotation object, added to the product model created in the past, in the design target model.

In addition, with respect to the annotation object of a part not existing in the design target model from among annotation objects added to the product model created in the past, the annotation object display attribute change unit 12d changes the display attribute of the annotation object. Accordingly, the designer can easily identify a verification point.

In addition, the connection target site search unit 12c searches the connection target site of the setting target model, which matches the condition of the model attribute. Owing to the search, it is possible to place the annotation object at a correct position.

In addition, examples of an application to which the registration processing and the annotation object setting processing according to the present embodiment are applicable include a 3-dimensional CAD, a 2-dimensional CAD, a virtual product simulator (VPS), an electrical CAD, an architectural CAD, a viewer, a digital mockup, and the like.

In addition, for example, as a method in which the annotation object placement position change unit 12e moves the annotation object in Step S30 in the flowchart illustrated in FIG. 17, the following methods (1) to (6) may be cited.

(1) When a model attribute to which an annotation object is connected completely matches the model attribute of a model existing at the position of the annotation object, the following moving method (a) or (b) may be considered.

(a) The annotation object is moved to the placement position (absolute coordinates) of the annotation object.

(b) The annotation object is moved to the placement position (relative coordinates) of a model connected to the annotation object.

(2) When a model attribute to which an annotation object is connected partially matches the model attribute of a model existing at the position of the annotation object, the following moving methods (a) to (f) may be considered.

(a) The annotation object is moved to the placement position (absolute coordinates) of the annotation object.

(b) The annotation object is moved to the placement position (relative coordinates) of a model connected to the annotation object.

(c) The model attributes of all models are searched, and a model is identified and the annotation object is moved to the placement position (relative coordinates) of the model, in accordance with a preliminarily defined priority criterion.

(d) An area is set with the original point of the annotation object as the center thereof, the model attribute of a model within the area is searched, and the model is identified and the annotation object is moved to the placement position (relative coordinates) of the model, in accordance with a preliminarily defined priority criterion.

(e) An area is set with the original point of the annotation object as the center thereof, the model attribute of a model within the area is searched, and the annotation object is moved to a coincident point located nearest the center, in accordance with a preliminarily defined priority criterion.

(f) The model attribute of a model in a displayed area is searched, and the model is identified and the annotation object is moved to the placement position (relative coordinates) of the model, in accordance with a preliminarily defined priority criterion.

(3) When the model attribute does not coincide at all, the following moving methods (a) to (d) may be considered.

(a) The annotation object is moved to the placement position

(absolute coordinates) of the annotation object.

(b) The model attributes of all models are searched, and a model is identified and the annotation object is moved to the placement position (relative coordinates) of the model, in accordance with a preliminarily defined priority criterion.

(c) An area is set with the original point of the annotation object as the center thereof, the model attribute of a model within the area is searched, and the model is identified and the annotation object is moved to the placement position (relative coordinates) of the model, in accordance with a preliminarily defined priority criterion.

(d) The model attribute of a model in a displayed area is searched, and the model is identified and the annotation object is moved to the placement position (relative coordinates) of the model, in accordance with a preliminarily defined priority criterion.

(4) In addition, depending on the kinds of connected annotation objects, the following moving methods (a) and (b) may be considered.

(a) The annotation object is moved to the placement position (absolute coordinates) of a connected model.

(b) The annotation object is moved to the placement position (relative coordinates) of a connected model.

(5) In addition, when a point (the starting point of a leader line) connected to a model overlaps the inside of a text display range, a method may be considered in which the point (starting point) connected to the model is fixed and the annotation object is moved so as not to overlap a point (ending point) other than the point connected to the model.

(6) When the moved annotation object overlaps another annotation object, a method may be considered in which a point (the starting point of a leader line) connected to a model is fixed and the annotation object is moved so as not to overlap a point (text display) other than the point connected to the model.

In addition, as an example of the above-mentioned priority criterion, a method may be cited in which a case where all model attributes (a part name, a figure number, and a file name) coincide is defined as the highest priority 1, a case where the model attributes (the part name and the figure number) coincide and a difference between the volumes of models is less than or equal to 10% thereof is defined as a priority 2, a case where only a difference between the volumes of models less than or equal to 10% thereof coincide, and a case where none of all the above-mentioned conditions coincides is defined as the lowest priority 4.

An example of a moving method according to the priority, a method may be considered in which the annotation object is moved to the placement position (relative coordinates) of a model connected to the annotation object at the case of the priority 1. A method may be considered in which the annotation object is moved to the placement position (relative coordinates) of the model connected to the annotation object at the case of the priority 2. At the case of the priority 3, the model attribute (part name) of a model in a displayed area is searched, and the annotation object is moved to the placement position (relative coordinates) of a corresponding model when the coincident model is found. A method may be considered in which the annotation object is moved to the placement position (absolute coordinates) of a model connected to the annotation object when a coincident model is not found.

A method may be considered in which the annotation object is moved to the placement position (relative coordinates) of a model connected to the annotation object at the case of the priority 4.

In addition, examples of a case in which the annotation object display attribute change unit 12d changes the display attribute in Step S31 in the flowchart illustrated in FIG. 17 include a case in which no model is found, a case in which a model completely matches all model attributes, a case in which a model matches a portion of model attributes, a case in which a model matches all or a portion of model attributes defined in a definition file, a case in which the coordinates of a model are equal to absolute coordinates at which the annotation object is placed, a case in which the coordinates of a model are equal to relative coordinates at which the annotation object is placed, a case in which the coordinates of a model are different from absolute coordinates at which the annotation object is placed, a case in which the coordinates of a model are different from relative coordinates at which the annotation object is placed, and the like.

In addition, examples of the changed display attribute include a nondisplay state, a semi-transparent state, a dotted line, a double line, hatching, a fence-line dotted line, a fence-line double line, filling, a dashed line, a wavy line, a chain line, a two-dot chain line, and the like.

In addition, the processing performed by the design support apparatus 10 may be processing distributed across a plurality of apparatuses. For example, one apparatus may create the view DB 31a and the annotation object DB 32a by performing processing operations ranging to the registration processing, and after that, another apparatus may perform the annotation object setting processing, using the view DB 31a and the annotation object DB 32a.

In addition, while, in the present embodiment, the view DB storage unit 31 and the annotation object DB storage unit 32 are provided outside the design support apparatus 10, the present embodiment is not limited to the example, and the view DB storage unit 31 and the annotation object DB storage unit 32 may be provided within the design support apparatus 10.

While the design support apparatus, the design support method, and the design support program according to the present invention have been described on the basis of illustrated embodiments this far, the present invention is not limited to the embodiments, and the configurations of individual portions may be replaced with arbitrary configurations having the same functions. In addition, other arbitrary components or processes may be added to the present invention.

In addition, the present invention may be a combination of more than one arbitrary configuration (feature) from among the described embodiments.

In addition, the above-described processing functions may be realized using a computer. In that case, a program is provided in which the processing content of a function to be included in the design support apparatus 1 or 10 is described. The computer executes the program, thereby realizing the above-mentioned processing function on the computer. The program in which the processing content is described may be recorded in a computer-readable recording medium. Examples of the computer-readable recording medium include a magnetic storage device, an optical disk, a magneto-optical recording medium, a semiconductor memory, and the like. Examples of the magnetic storage device include a hard disk device (HDD), a flexible disk (FD), a magnetic tape, and the like. Examples of the optical disk include a DVD, a DVD-RAM, a CD-ROM/RW, and the like. Examples of the magneto-optical recording medium include a magneto-optical disk (MO) and the like.

When the program is distributed, portable recording media such as DVDs, CD-ROMs, and the like in which the program is recorded are marketed, for example. In addition, the program may be stored in a storage device in a server computer and the program may be transferred from the server computer to other computers through a network.

For example, a computer that executes the program stores, in a storage device in the computer itself, the program recorded in the portable recording medium or the program transferred from the server computer. In addition, the computer reads out the program from the storage device in the computer itself, and executes processing according to the program. In addition, the computer may also directly read out the program from the portable recording medium and execute processing according to the program. In addition, the computer may also sequentially execute processing according to the received program every time the program is transferred from the server computer connected through the network.

In addition, at least a portion of the above-described processing functions may also be realized using an electronic circuit such as a digital signal processor (DSP), an application specific integrated circuit (ASIC), a programmable logic device (PLD), or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A design support apparatus comprising:
a search unit configured to refer to a first database including annotation information pieces added to a first product model and site identification information pieces associated with the annotation information pieces, respectively, each of the site identification information pieces being for identifying a first site to which the associated annotation information piece is added in the first product model, the search unit being configured to search, in a second product model, a second site corresponding to the first site identified by the site identification information piece; and
a placement unit configured to place the annotation information piece associated with the corresponding site identification information piece at the second site when the search unit determines that the second site exists in the second product model.

2. The design support apparatus according to claim 1, wherein
the first database includes position information pieces of the annotation information pieces,
the search unit is configured to determine, with respect to each of the annotation information pieces, whether or not the first site identified by the associated site identification information piece exists at a position identified by the position information piece of the annotation information piece in the second product model, and
the placement unit is configured to place the annotation information piece at the position when the search unit determines that the first site identified by the associated site identification information piece exists at the position in the second product model.

3. The design support apparatus according to claim 1,
wherein identifiers are added to the annotation information pieces, respectively,
the design support apparatus further comprising:
an extraction unit configured to refer to a second database including the identifiers and a display information piece associated with the identifiers, the display information piece indicating a first display state of the first product model, the extraction unit being configured to extract the first display state from the second database on the basis of the identifiers; and
a display state change unit configured to cause the first display state extracted by the extraction unit and a second display state of the second product model to match each other.

4. The design support apparatus according to claim 1, wherein,
when the search unit determines that the second site does not exist in the second product model, the placement unit is configured to change a display state of the annotation information piece associated with the corresponding site identification information piece and places the annotation information piece with the changed display state.

5. The design support apparatus according to claim 1, wherein
the annotation information piece is managed by the associated site identification information piece with the annotation information piece being separated with respect to each of shapes.

6. A design support method comprising:
referring to a first database including annotation information pieces added to a first product model and site identification information pieces associated with the annotation information pieces, respectively, each of the site identification information pieces being for identifying a first site to which the associated annotation information piece is added in the first product model;
searching, by a computer, in a second product model, a second site corresponding to the first site identified by the site identification information piece; and
placing, by the computer, the annotation information piece associated with the corresponding site identification information piece at the second site when the searching determines that the second site exists in the second product model.

7. The design support method according to claim 6, wherein
the first database includes position information pieces of the annotation information pieces,
the searching includes determining, with respect to each of the annotation information pieces, whether or not the first site identified by the associated site identification information piece exists at a position identified by the position information piece of the annotation information piece in the second product model, and
the placing includes placing the annotation information piece at the position when the searching determines that the first site identified by the associated site identification information piece exists at the position in the second product model.

8. The design support method according to claim 6,
wherein identifiers are added to the annotation information pieces, respectively,
the design support method further comprising:
referring to a second database including the identifiers and a display information piece associated with the identifiers, the display information piece indicating a first display state of the first product model;
extracting the first display state from the second database on the basis of the identifiers; and
changing a display state of the first product model so as to cause the extracted first display state and a second display state of the second product model to match each other.

9. The design support method according to claim 6, wherein,
when the searching determines that the second site does not exist in the second product model, the placing includes changing a display state of the annotation information piece associated with the corresponding site identification information piece and placing the annotation information piece with the changed display state.

10. The design support method according to claim 6, wherein
the annotation information piece is managed by the associated site identification information piece with the annotation information piece being separated with respect to each of shapes.

11. A non-transitory computer-readable medium that stores therein a design support program, the design support program causing a computer to execute a design support process, the design support process comprising:
referring to a first database including annotation information pieces added to a first product model and site identification information pieces associated with the annotation information pieces, respectively, each of the site identification information pieces being for identifying a first site to which the associated annotation information piece is added in the first product model;
searching, in a second product model, a second site corresponding to the first site identified by the site identification information piece; and
placing the annotation information piece associated with the corresponding site identification information piece at the second site when the searching determines that the second site exists in the second product model.

12. The non-transitory computer-readable medium according to claim 11, wherein
the first database includes position information pieces of the annotation information pieces,
the searching includes determining, with respect to each of the annotation information pieces, whether or not the first site identified by the associated site identification information piece exists at a position identified by the position information piece of the annotation information piece in the second product model, and
the placing includes placing the annotation information piece at the position when the searching determines that the first site identified by the associated site identification information piece exists at the position in the second product model.

13. The non-transitory computer-readable medium according to claim 11,
wherein identifiers are added to the annotation information pieces, respectively,
the design support process further comprising:
referring to a second database including the identifiers and a display information piece associated with the identifiers, the display information piece indicating a first display state of the first product model;
extracting the first display state from the second database on the basis of the identifiers; and
changing a display state of the first product model so as to cause the extracted first display state and a second display state of the second product model to match each other.

14. The non-transitory computer-readable medium according to claim 11, wherein,
when the searching determines that the second site does not exist in the second product model, the placing includes changing a display state of the annotation information piece associated with the corresponding site identification information piece and placing the annotation information piece with the changed display state.

15. The non-transitory computer-readable medium to claim 11, wherein
the annotation information piece is managed by the associated site identification information piece with the annotation information piece being separated with respect to each of shapes.
